(19) United States
(12) Patent Application Publication
(10) Pub. No.: US 2014/0002722 A1
(43) Pub. Date: Jan. 2, 2014

(54) IMAGE ENHANCEMENT METHODS

(71) Applicants: Gerald P. Cook, Bromsash (GB); Anthony D. Jacques, Hampshire (GB); Brian R. Trethewey, Ottawa (CA)

(72) Inventors: Gerald P. Cook, Bromsash (GB); Anthony D. Jacques, Hampshire (GB); Brian R. Trethewey, Ottawa (CA)

(73) Assignee: 3M Innovative Properties Company

(21) Appl. No.: 13/534,371

(22) Filed: Jun. 27, 2012

(51) Int. Cl. H04N 5/222

(52) U.S. Cl. 348/370; 348/E05.029

(57) ABSTRACT

Methods of image enhancement are disclosed. In one aspect, the method of image enhancement is for use with an image capture device, such as a security document reader, for the attenuation, separation or reduction of reflections from objects, such as security documents.

### BACKGROUND

Security documents such as passports, identification cards, national healthcare cards, driver's licenses, entry passes, ownership certificates, financial instruments, and the like, are often assigned to a particular person by personalization data. Personalization data, often present as printed images, can include photographs, signatures, fingerprints, personal alphanumeric information, and barcodes, and allows human or electronic verification that the person presenting the document for inspection is the person to whom the document is assigned. There is widespread concern that forgery techniques can be used to alter the personalization data on such a document, thus allowing non-authorized people to pass the inspection step and use the document in a fraudulent manner.

A number of security features have been developed to help authenticate the document of value, thus assisting in preventing counterfeiters from altering, duplicating or simulating a document of value. Some of these security features may include overt security features or covert security features. Overt security features are features that are easily viewable to the unaided eye, such features may include holograms and other diffractive optically variable images, embossed images, and color-shifting films. In contrast, covert security features include images only visible under certain conditions, such as inspection under light of a certain wavelength, polarized light, or retroreflected light. One example of a laminate that includes both overt and covert security features is 3M™ Confirm™ Laminate with Floating Image Technology, which is commercially available from 3M Company based in St. Paul, Minn. This security laminate may be used with security documents, such as identification cards, badges and driver licenses, and assists in providing identification, authentication and to help protect against counterfeiting, alteration, duplication, and simulation. Another example of a laminate that includes both overt and covert security features is illustrated in U.S. Pat. Publication No. 2003/0170425 A1 “Security Laminate,” (Mann et al.).

In recent years, there has been widespread adoption of automated reading of security documents at border entry points and other situations where the identity of a document holder requires verification. Automated reading ranges from an optical scan of OCR-readable data to the interrogation of an RFID chip within a passport or identification card, which may then involve further checking by an operator or verification by an automated system, such as an e-passport gate as found in major airports. Data may also be contained in a magnetic strip or transferred wirelessly depending on the format of the document in which identity information is contained.

Optical reading of a security document is typically carried out with document readers using one or a combination of visible, infrared and ultraviolet light, depending on the information being retrieved. Often overt and covert optical security features, such as those discussed above, are included within security documents to allow the document itself to be authenticated as genuine. As discussed, covert security features may only be visible under certain illumination, such as infrared or ultraviolet light, or may, such as with an optically variable device, provide variable information when illuminated from different directions. In each case the security document is typically read by placing the document on a glass platen of a document reader, such that the information contained on the portion of the document in contact with the platen is illuminated from within the document reader. Light reflected by the document is reflected back into the reader and processed to form an image of the information (e.g. text or covert or overt security features) required. The quality of the image captured is affected greatly by the manner in which the document reflects the incident light.

A variety of security readers are known in the art. For example, U.S. Pat. No. 6,288,842, “Security Reader for Automatic Detection of Tampering and Alteration, (Mann) discloses a security reader for reading and processing information about security laminates. One example of a passport reader is commercially available from 3M Company based in St. Paul, Minn., as the 3M™ Full Page Reader.

Image enhancement by removal of unwanted reflections in image capture devices is disclosed in U.S. Pat. No. 7,136,537, “Specular Reflection in Captured Images,” (Pilu et al.). In order to remove specular reflections, two images are taken, one containing specular reflections and one where such reflections are absent. These images are blended together to create an image with reduced specular reflection, allowing underlying features to be seen. The apparatus used to achieve this effect is provided with an adjustor that is able to vary the amount of specular reflection appearing in the final image. Images are taken with one or more strobes or flashes from various directions relative to the object being imaged, and relies on each image having an absence of glare patches seen in another image. Such a method therefore takes into account reflections generated by ambient light conditions, and is not suitable for use in a document reader, for example, where illumination is well controlled and reflection features are generated by artefacts in the document being imaged, rather than artefacts generated by variations in ambient illumination.

### SUMMARY

One aspect of the present invention provides an image enhancement method for an image capture device. This method comprises: illuminating an object placed on, in or adjacent to the image capture device and capturing an image of the object from a first position to obtain a first set of raw pixel data; illuminating the object placed on, in or adjacent to the image capture device and capturing an image of the object from a second position, to obtain a second set of raw pixel data, wherein each pixel in the second set of raw pixel data corresponds to a pixel in the first set of raw pixel data representing a point on the object; calibrating each of the first and second sets of raw pixel data using a set of image calibration pixel data to create a first set of image pixel data and a second set of pixel image data; and calculating a first set of final image data by: comparing the first and second sets of image pixel data; for pixels representing the same point on the object, selecting the pixel with the lowest pixel intensity; and including said pixel in the first set of final image data.

The above summary of the present invention is not intended to describe each disclosed embodiment or every implementation of the present invention. The Figures and the detail description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1 is a schematic side view of a document reader in which an embodiment of the method of the present invention is carried out;

FIG. 2 is a schematic side view of one type of optical defect in a security document giving rise to a specular reflection;

FIG. 3A is a schematic illustration of an image of a passport bio-data page illuminated from a first direction to show a first reflection feature;

FIG. 3B is a schematic illustration of an image of a passport bio-data page illuminated from a second direction to show a second reflection feature;

FIG. 3C is a schematic illustration of an image of the passport bio-data page of FIGS. 3A and 3B with no reflection features visible;

FIG. 4 is a chart illustrating the pixel intensity of a raw pixel data set I_{PR} against distance d from the source of illumination;

FIG. 5 is a chart showing the final pixel intensity I_{PF} of the pixels in the first set of pixel image data (as an example) against distance d from the source of illumination;

FIG. 6 is a chart showing pixel intensity I_{P} against apparent greyness G (the response of the image capture device across the spectrum imaged) for decreasing pixel intensity;

FIG. 7 is a schematic example of the effect that gamma correction has on text within an image;

FIG. 8 is a schematic illustration of a portion of the color sensor array for an image capture device; and

FIG. 9 is a flow chart illustrating the preferred embodiment of the present invention.

### DETAILED DESCRIPTION

Security documents such as passports, identification cards, and the like, may often have either a matte or a shiny finish, and is unlikely to be completely flat. During use, corners of plastic bio-data pages in passports, for example, may bend, air bubbles and dirt may become trapped within a laminate structure, or a surface material may be highly reflective and shiny in appearance, all of which can create unwanted reflections, generally specular reflections, thus distorting the captured image. This may make machine readable text, such as OCR text, overt and covert security features difficult to read, and make automatic authentication of the document and/or verification of the holder unreliable or impossible. For example, a bio-data page having a laminate construction with an extremely shiny surface may require additional inspection by an operator if specular reflections distort the image beyond the capability of an automatic reader.

With the various constraints on security document imaging in mind, there is a need for a method that allows the image taken by a standard security document reader to be enhanced sufficiently that stray and unwanted reflections are no longer an issue, such that the document can be authenticated reliably and accurately regardless of surface quality or illumination conditions. Such a method may also find applications in other image capture techniques.

The present invention aims to address these issues by providing an image enhancement method for an image capture device; the method comprising the steps of: illuminating an object placed on, in or adjacent to the image capture device and capturing an image of the object from a first position to obtain a first set of raw pixel data; illuminating the object placed on, in or adjacent to the image capture device, capturing an image of the object from a second position to obtain a second set of raw pixel data, where each pixel in the second set of raw pixel data corresponds to a pixel in the first set of raw pixel data representing a point on the object; calibrating each of the first and second sets of raw pixel data using a set of image calibration pixel data to create a first set of image pixel data and a second set of pixel image data respectively; and calculating a first set of final image data by: comparing the first and second sets of image pixel data; for pixels representing the same point on the object, selecting the pixel with the lowest pixel intensity; and including said pixel in the first set of final image data.

The advantage of using such an approach is that only pixels representing a portion of an image in which a reflection is absent are used to make up the set of final image data, thus ensuring that any image recovered is of a high quality with reflections either attenuated or removed. In some circumstances, reflections may in fact be separated, for example, specular reflections are removed, but reflections from single color features remain. This is particularly advantageous for a security document, such as an identification document or a fiduciary document, where covert or overt security features may be revealed as single color reflections.

In one aspect of the present invention, calibrating each of the first and second sets of raw pixel data comprises using a first set of image calibration pixel data to create a first set of image pixel data and using a second set of image calibration pixel data to create a second set of pixel image data respectively, where each pixel in the second set of image calibration pixel data corresponds to a pixel in the first set of image calibration pixel data, and each pixel in the first and second sets of image calibration pixel data corresponds to a pixel in each of the first and second sets of raw pixel data respectively.

In another aspect of the present invention, the object is illuminated with one of visible light, infra-red light and ultraviolet light. More preferably, when the object is illuminated with visible light, the object is illuminated with white light.

The pixel intensity may have balanced red-green-blue components. Alternatively, the pixel intensity may have un-balanced red-green-blue components. In this situation, preferably the pixel intensity has a maximum red, green or blue component. In another aspect of the method of the present invention, the method may also further comprise the steps of, for each pixel in the first and second sets of raw pixel data, measuring the intensity of single color reflections, and for pixels representing the same point on the object, selecting the pixel with the brightest single color intensity; and including said pixel in the set of final image data. In yet another aspect of the method of the present invention, the method may further comprise the step of adjusting the first and second sets of image pixel data with a gamma correction.

In another aspect of the method of the present invention, the image enhancement output is the attenuation, separation or removal of reflections. More preferably, the image enhancement output is the attenuation, separation or removal of specular reflections.

In yet another aspect of the method of the present invention, the method may also further comprise the step of: for each of the first and second sets of raw pixel data, compensating the intensity values of each pixel for ambient light. In another aspect, the method of the present invention may further comprise the steps of: creating a set of ambient pixel data by imaging the object under no illumination other than ambient light and then subtracting the set of ambient pixel data from each of the first and second sets of raw pixel data.

In yet another aspect, it may also be desirable for the method of the present invention to further comprise the steps of: creating a second set of final image data by comparing the first and second sets of image pixel data; for pixels representing the same point on the object, selecting the pixel with the highest pixel intensity; and including said pixel in a second set of final image data.

In another aspect, the method of the present invention may also further comprise the steps of creating a mask based on the second set of final data by applying a threshold to the second set of final image data, and applying the mask to the second set of final image data.

Preferably, the image capture device is a security document reader and the object is a security document. More preferably, the security document is an identity document or a fiduciary document. Yet more preferably, the security document is one of a passport, an identification card, or a driver's license.

In the present invention, a “darkest pixel” approach of image enhancement has been created to form an image of a security document that is substantially free of unwanted reflections, as explained in further detail below. The method comprises illuminating the object placed on, in or adjacent to an image capturing device, such as a document reader, from a first position to obtain a first set of raw pixel data, and illuminating the object placed on or in a document reader from a second position, different to the first position, to obtain a second set of raw pixel data. As one example, the object may be illuminated at a first angle relative to the document in the first position, and then the object may be illuminated at a second angle relative to the document, different from the first angle, in the second position. Each of these first and second sets of raw pixel data are calibrated using a set of image calibration pixel data to create a first set of image pixel data and a second set of pixel image data respectively. A final set of image data is then calculated by comparing the first and second sets of image pixel data. In this comparison, for pixels representing the same point on the security document, the pixel with the “darkest pixel” or lowest pixel intensity measured is selected, and included in the set of final image data. By considering darkest only pixels, an image substantially without reflections is revealed. In addition, the present invention also envisages an additional step of considering “brightest only” pixels or those with the highest pixel intensity measured, which enhances the reflections present when the object is illuminated. By attenuating, separating or removing unwanted reflections, in particular, specular reflections, the reliability of automated authentication of a security document, either by text or overt security feature recognition or by revelation of covert security features is improved.

In the following embodiments, the example of a security document and sourcing document reader is used. However, as described below, in alternative embodiments, the method of the present invention is suitable for use with other objects and image captive devices.

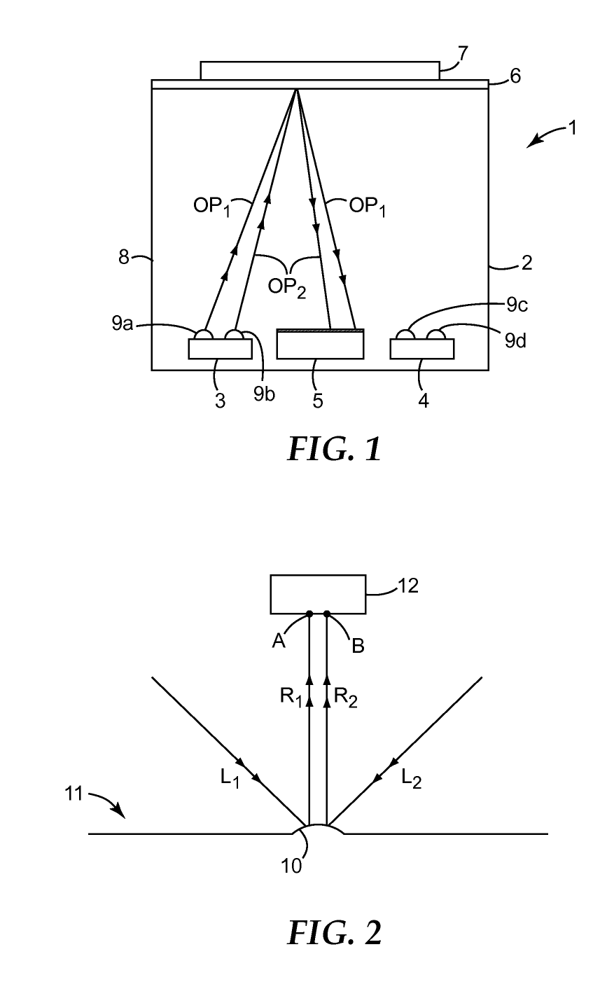

FIG. 1 is a schematic side view of a document reader in which an embodiment of the method of the present invention is carried out. The document reader 1 is generally cuboid in shape, and comprises a housing 2 in which first 3 and second 4 illumination sources and an image capture device 5 are positioned. The uppermost surface of the housing 2 is formed from a glass platen 6, onto which a security document 7 may be placed in order to be imaged.

In this embodiment, in order to enable illumination of the document from a first and a second direction, the first 3 and second 4 lighting sources are positioned on either side of the image capture device 5, which is disposed centrally within the housing 2 adjacent a wall 8 of the housing. Each illumination source 3, 4 is provided with a linear array of light emitting diodes 9a, 9b, 9c, 9d (only two of which are shown on each of the first 3 and second 4 lighting sources for clarity), aligned to illuminate the entire surface of a security document 7 in contact with the glass platen 6. Light travels along the optical paths OP₁ and OP₂ to be incident on the glass platen 6 and document 7, and reflected back to the surface of the image capture device 5. Non-limiting example optical paths are shown for the first illumination source 3 only. Second illumination source 4 may include similar optical paths, although not illustrated. Preferably the light emitting diodes emit light in the visible range of the electromagnetic spectrum, with suitable LEDs being available from Osram Opto Semiconductors under the product code “TOPLED Ultra White 2PLCC”. The image capture device 5 is preferably a CMOS device, such as the MT9T001 ½ inch 3-megapixel digital image sensor, available from Micron Technologies, Inc., located in Boise, Id., USA.

The document reader 1 illustrated in FIG. 1 is arranged so as to enable a method involving imaging a security document from a first and a second direction, where the second direction is different from the first direction. Using two different illumination directions allows images of the same point on the security document to be taken that yield different optical effects. This is generally illustrated in FIG. 2.

FIG. 2 is a schematic side view of an optical defect in a security document giving rise to a specular reflection. Specular reflections may be anything that includes an optical glare reflecting back from a surface. Examples of specular reflection in a security document may be caused an uneven laminate, uneven surface that is not optically flat, or the material itself, such extra shiny laminates. In general, specular reflections are mirror or glass-like reflections. In the case of a security reader, there are artifacts or material properties in the security laminates of a security document that cause bright white spots where the light from the light source(s) is reflected back to the image capture device. As one example, an optical defect 10 is present in the surface of a security document 11, in this case, a bubble in a laminated bio-data page structure. Light from a first direction L₁ is incident on a first side of the defect 10 and reflected R₁ onto an image capture device 12. This gives an image with a bright spot corresponding to reflection from the surface of the defect 10 on which the light L₁ was incident. Light from a second direction L₂ is incident on a first side of the defect 10 and reflected R₂ onto an image capture device 12. This gives an image with a bright spot corresponding to reflection from the surface of the defect 10 on which the light L₂ was incident. These two images of the same section of the security document 11 will appear to be subtly different when compared to each other. When light reflected from the defect 10 is incident on the image capture device 12, different pixel intensities for the same point on the security document are obtained as follows. The image capture device 12 contains an array of cells each of which has a one-to-one relationship with a pixel in an image of the security document 11. When illuminated from a first direction with light L₁ the first set of raw pixel data obtained will contain a bright pixel at the point where the reflection R₁ is incident on the image capture device, at position A. When illuminated from a second direction with light L₂ the second set of raw pixel data obtained will contain a bright pixel at the point where the reflection R₂ is incident on the image capture device, at position B. When these two data sets are combined the darkest pixel (e.g. the pixel with the lowest pixel intensity measured for each equivalent pixel) will be found in the second raw pixel data set at point A and in the first raw pixel data set at point B. A final image formed from combining data based on these two data sets and using only the darkest pixels at each position on the security document, such that reflections from the defect 10 are effectively removed from this final image. This is possible as each pixel in the second set of raw pixel data corresponds to a pixel in the first set of raw pixel data representing a point on the security document. In this example, the security document 10 remains stationery whilst being illuminated from two different positions, creating incident illumination effectively from a first angle and a second angle, different to the first.

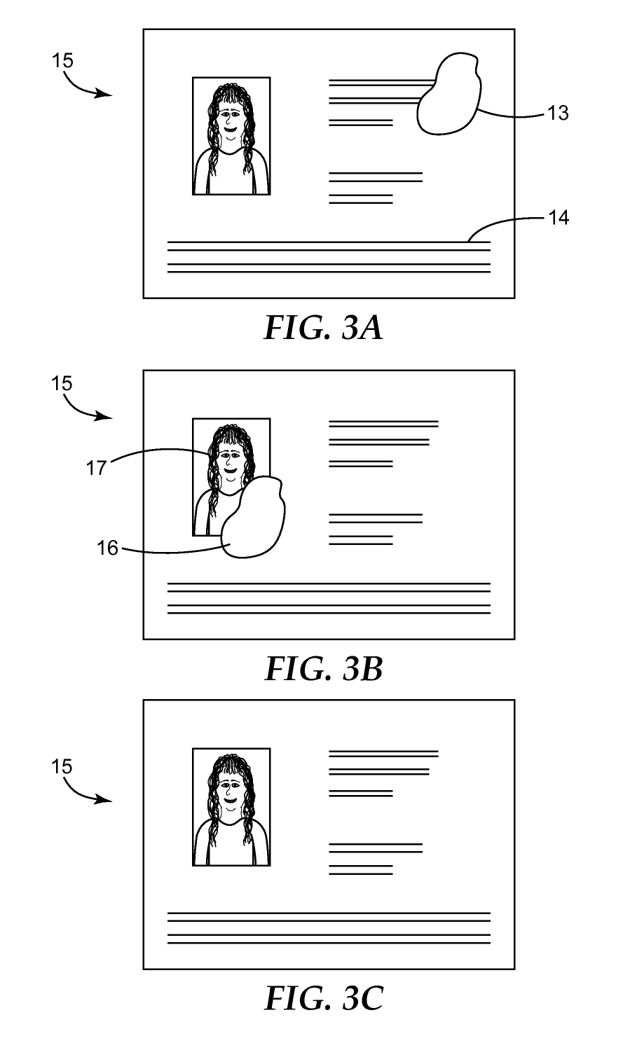

This idea is illustrated further in FIGS. 3A, 3B and 3C. FIG. 3A is a schematic illustration of an image of a passport bio-data page illuminated from a first direction L₁ to show a first reflection feature. A bio-data page is chosen in this example as typically this is comprised of a multilayer laminated structure with at least one plastic or reflective layer or region on the page containing identity information about the passport bearer. However, the method described below is equally suitable for any page or surface of a security document that requires imaging for bearer identification and/or document authentication to take place. The first reflection feature 13 is a specular reflection obscuring a portion of text 14 on the bio-data page 15. This is caused, for example, by a defect within the laminated structure of the bio-data page 15. FIG. 3B is a schematic illustration of an image of a passport bio-data page illuminated from a second direction L₂ to show a second reflection feature. The second reflection feature 16 is a specular reflection obscuring a portion of the photograph 17 of the holder of the bio-data page 15. This is caused, for example, by the inclusion of a reflective covert security feature within the bio-data page 15. FIG. 3C is a schematic illustration of an image of the passport bio-data page of FIGS. 3A and 3B with no reflection features visible. This image is formed from a comparison of the two images in FIGS. 3A and 3B and taking the darkest pixel approach or lowest pixel intensity to select pixels revealing a reflection free image.

In order to utilise a darkest pixel only approach to its fullest extent it is necessary to ensure that the data collected in the first and second raw pixel data sets is as accurate as possible. To achieve this, two factors must be born in mind. Firstly, a document reader, such as a security document reader, has a limited footprint due to size restrictions in the environment in which it is used, which would typically be a desk or cubicle at a border inspection point. This then places constraints on the optical system within the document reader, as to enable illumination of an entire security document placed on the reader lighting source often need to be positioned adjacent a wall or corner of the housing of the document reader, as in the example given above. This causes a variation in the intensity of illumination of the security document with distance away from the lighting source, and consequently a spatial distribution of pixel intensity in image obtained. Secondly, the image capture device typically has an inherent non-linear response to intensity of illumination and color, leading to a variation between a real intensity for a particular shade and an ideal intensity for the same shade. For a methodology that relies on being able to select the darkest version of a pixel, any discrepancy in illumination and/or color definition can have a detrimental effect on the data unless corrected.

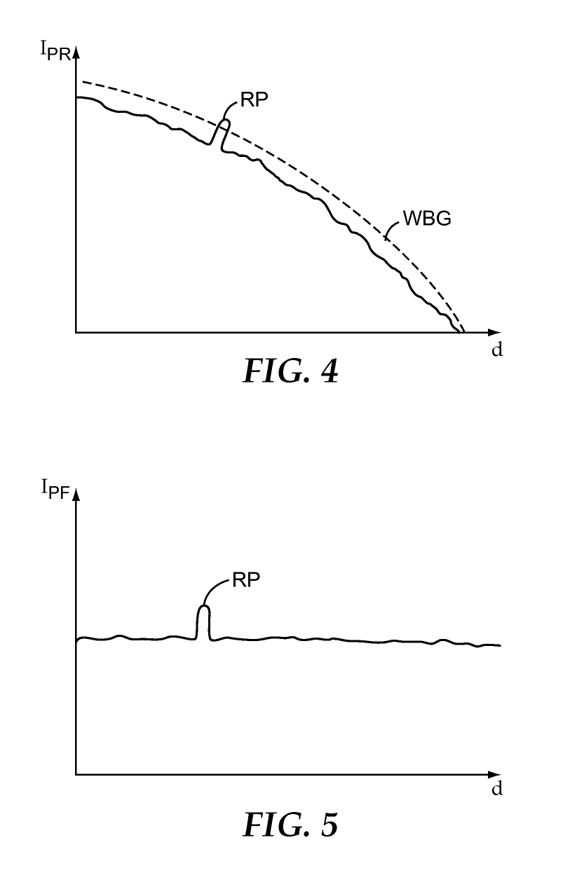

FIG. 4 is a chart illustrating the pixel intensity of a raw pixel data set I_{PR} against distance from the source of illumination d. This illustrates the effect of the spatial distribution of the light emitted from the lighting sources 3, 4, within the document reader 1 and incident on the security document 7. In this example, the lighting source 3 is positioned adjacent d=0, such that the highest pixel intensity of raw pixel data I_{PR} occurs at this point. As the distance d away from the lighting source 3 increases the pixel intensity drops off substantially following a mean inverse square approximation. The relationship shown is appropriate for two lighting sources, whereas for a greater number of lighting sources, the resulting intensity relationship is created using a mean inverse square approach resulting in a saddle-shaped intensity distribution. In this example, approximately half-way between the highest and lowest pixel intensities a reflection peak RP is seen. However, given the general noise within the data and the decreasing pixel intensity, with distance d in this position it is likely that the reflection peak would be detected and the darkest pixel method used successfully. However, a peak found at an increased value of d, and therefore further into the region of decreasing pixel intensity may be harder to detect due to noise, and therefore calibration of the raw pixel data to avoid this is advisable.

This variation in pixel intensity can be corrected using a set of calibration pixel data. Each of the first and second raw pixel data sets will have an intensity distribution similar to that shown in FIG. 4. Also shown on FIG. 4 is a line marked “WBG” representing white background intensity. This is effectively the pixel intensity for a plain white background, such as a sheet of white paper or card, imaged using the document reader 1. By allocating pixel intensity in the WBG to represent the background value of pixel intensity in the raw pixel data sets, a set of calibration pixel data is created. When this set of calibration pixel data is combined with the raw pixel data in a mathematical operation as shown in Equation 1 below the pixel image data is returned:

Output=(255×Input)/(WBG+c) Equation 1

Output=output pixel intensity in pixel image data
Input=input pixel intensity in raw pixel data
255=maximum intensity value allocated to the cell in the image capture device
WBG=intensity of corresponding pixel in calibration pixel data
c=constant, greater than 0 and preferably 1, included to ensure that the Output value is not infinite.

This operation is completed for both the first set of raw pixel data and the second set of raw pixel data to obtain the first and second sets of image pixel data respectively. FIG. 5 is a plot showing the final pixel intensity I_{PF} of the pixels in the first set of pixel image data (as an example) against distance from the source of illumination d. It can be seen that the background intensity is now substantially flat with increasing distance, and the reflection peak RP seen clearly above the background intensity, allowing the darkest pixel to be chosen easily and accurately. Since the two sets of raw pixel data are different, calibrating each of the first and second sets of raw pixel data comprises using a first set of image calibration pixel data to create a first set of image pixel data and using a second set of image calibration pixel data to create a second set of pixel image data respectively. Each pixel in the second set of image calibration pixel data corresponds to a pixel in the first set of image calibration pixel data, and each pixel in the first and second sets of image calibration pixel data corresponds to a pixel in each of the first and second sets of raw pixel data respectively.

The calibrated first and second sets of image pixel data may then be used to calculate a first set of final image data by selecting the darkest pixel for each comparable point in an image of the same point on the image of the security document. This may be done using a simple code loop as follows:

If Pixel₁ < Pixel₂

OutputPixel = Pixel₁

Else

OutputPixel = Pixel₂

Endif

Where Pixel₁ is a pixel in the first pixel image data set and Pixel₂ is corresponding pixel in the second pixel image data set. This loop is repeated for each corresponding pixel in the first and second pixel image data sets, until a first set of final image data is created from the OutputPixel values found.

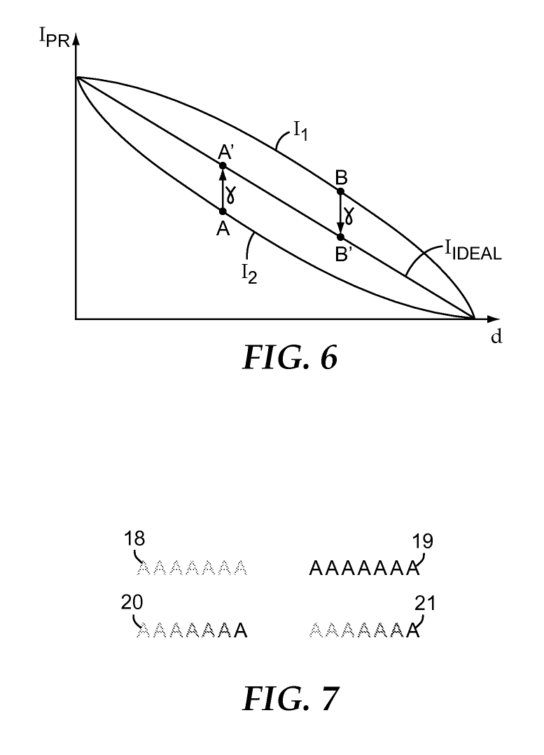

However, as is evident from FIG. 6, it may be desirable to make a further correction, such as a gamma correction, to take into account the inherent non-linear response to intensity of illumination and color, leading to a variation between a real intensity for a particular shade and an ideal intensity for the same shade. FIG. 6 is a chart showing pixel intensity I_{P} against apparent greyness G (the response of the image capture device across the spectrum imaged) for decreasing pixel intensity. In the centre of the response range the non-linear behaviour of the image capture device is at its most stark—with the greatest deviation being either above (I₁) or below (I₂) the ideal intensity I_{IDEAL}. The direction in which the deviation occurs is an artefact of the image capture device used, hence both upper and lower deviations are illustrated here for the purposes of explanation. In order to ensure that the pixel intensity is as close to the ideal intensity as possible a correction factor, often known as gamma correction, is used. When applied to the pixel intensity at point A on curve I₂, the pixel intensity will be corrected to point A′ on the line I_{IDEAL}, and when applied to the pixel intensity at point B on curve I₂, the pixel intensity will be corrected to point B′ on the line I_{IDEAL}. Gamma correction is an exponential function typically in the form shown in Equation 2 below:

Vₒᵤₜ=AVᵢₙ^{γ} Equation 2

Where Vₒᵤₜ is output, Vᵢₙ is input, A is a constant and γ is the gamma exponential correction factor. A gamma correction is applied to the first set of final image data if required to ensure that the data quality in the first set of final image data is as high as possible, making it ideal as a starting point for further processing as part of a document authentication process. FIG. 7 is a schematic example of the effect that gamma correction has on text within an image. The upper line of text contains a first group of letters 18 (all letter “A”) corresponding to low illumination intensity (i.e. at a large distance d from the lighting source) and thus appear all in a lighter shade of gray, and a second group of letters 19 (all letter “A”) corresponding to high illumination intensity (i.e. at a small distance d from the lighting source) and thus appear all in a darker shade of gray. Both groups 18, 19 are without gamma correction. The lower line of text contains a third group of letters 20 (all letter “A”) corresponding to low illumination intensity (i.e. at a large distance d from the lighting source) and a fourth group of letters 21 (all letter “A”) corresponding to high illumination intensity (i.e. at a small distance d from the lighting source), both with gamma correction. The effect of gamma correction on an image is that for the letters in the third group 20 and fourth group 21 there is a greater contrast between individual shades, and a greater contrast between lighter shades (low illumination) and darker shades (bright illumination) in general (i.e. the contrast between the entire third group 20 and the entire fourth group 21).

Extraction of further image features, such as covert security features hidden within the security document being imaged, or further correction and enhancement of the raw image pixel data, will now be described with respect to further embodiments of the present invention.

Although in the above embodiment no distinction is made in relation to the color of reflection, under examination in a first further embodiment features may be separated, attenuated, highlighted or removed by considering brightest single color intensities as a complement to the darkest pixel approach outlined above. For specular reflections RGB (red, green and blue intensity) values are typically balanced out creating a bright white spot. However, for security features, often only one of the RGB values is maximised, since the feature is brighter in a single color only. So for the darkest only pixel approach outlined above, the pixel intensity has balanced red-green-blue components, since this corresponds to a white, specular reflection. For a security feature, the pixel intensity has un-balanced red-green-blue components. This may in fact be that pixel intensity has a maximum red, green or blue component.

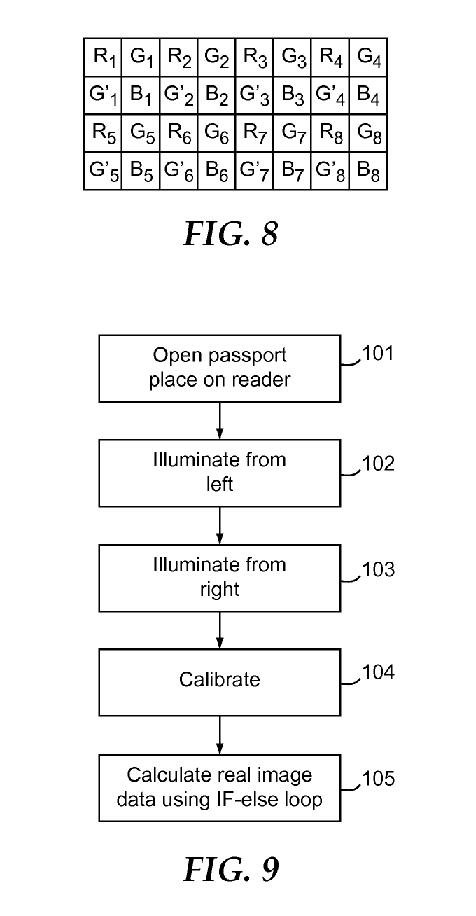

FIG. 8 is a schematic illustration of a portion of the color sensor array for an image capture device. This is typical of a CMOS-type device used in the embodiment above.

Sensors are grouped into groups of four each comprising a red detector cell (R₁-R₈), a blue detector cell (B₁-B₈) and two green detector cells (G₁-G₈, G′₁-G′₈), representing a cell having a one-to-one relationship with a pixel in a final image. Each sensor detects the appropriate color, with two green detector sensors being included in each group to mimic the response of a human eye. The color response of a reflection, i.e. determination of a pixel having the brightest single color intensity, is measured by considering the response of individual sensors within each group and adjacent sensors within each group and/or adjacent groups. For example, a reflection with an intense blue component can be detected by merely looking at the response of the blue detector sensors or the red and green detector sensors (for the presence or absence of a response) or by looking at the response of adjacent blue detector sensors. For example, saturation of the blue B₂ sensor would result in the response of the blue B₁, B₃ and B₅ sensors being examined as strong response here would indicate a reflection peak. Consequently, by additionally measuring the color intensity of single color reflections by examining the color response of the pixels in the first and second sets of raw pixel data, for pixels representing the same point on the security document, the pixel with the brightest single color intensity can be selected and included in the first set of final image data. As an alternative to using the RGB color space it may be desirable to use a different color space, such as L*a*b*, since this mimics the natural response of the eye more accurately than RGB space, which is advantageous when an operator compares images on a screen and the actual security document.

In a second further embodiment of the present invention it is also possible select only the reflections seen within the image of a security document and to produce an image showing such reflections, rather than an image where such reflections are separated, attenuated or removed. The calibrated first and second sets of image pixel data may then be used to calculate a second set of final image data by selecting the highest pixel for each comparable point in an image of the same point on the image of the security document. This may be done using a simple code loop as follows:

If Pixel₁ > Pixel₂

OutputPixel = Pixel₁

Else

OutputPixel = Pixel₂

Endif

Where Pixelₛ is a pixel in the first pixel image data set and Pixel₂ is corresponding pixel in the second pixel image data set. This loop is repeated for each corresponding pixel in the first and second pixel image data sets, until a second set of final image data is created from the OutputPixel values found. This second set of final image data can be displayed to a user as an alternative image or as an additional image, allowing comparison between an image of a security document having reflections separated, attenuated or removed and an image of the same security document showing only the reflections.

In the examples given above, no correction is required for the effects of ambient lighting (i.e. light generated by the surrounds of the document reader rather than by the document reader), since typically document readers are used in an enclosed situation, for example, by providing a hood or lid covering the security document during illumination. However, in some circumstances, such as when a document reader is used in a booth or other open environment, it may be desirable to correct the image obtained by removing the intensity component attributable to ambient light. In a further embodiment of the present invention, this is done by creating a set of ambient pixel data by imaging the security document under no illumination other than ambient light. This may be achieved by placing the security document onto the glass platen 6 of the document reader 1 and without activating any of the lighting sources, capturing an image of the security document 7, thus creating the set of ambient pixel data. This set of ambient pixel data is then subtracted from each of the first and second sets of raw pixel data. This may be done at the same time as other calibration operations, beforehand or afterwards, but before the first or second sets of final image data are created.

In yet a further embodiment of the present invention it is possible to carry out a thresholding exercise to minimise the effects of noise in the background pixel intensity surrounding a reflection peak. This enables the creation of a mask to highlight reflections and remove any background noise or artefacts. As described above, it is possible to create a second set of final image data in which reflections are included. A mask, based on the second set of final image data, is created by applying a threshold to the second set of final image data. The threshold is chosen to remove all background noise, and for example, could typically be chosen to be approximately 50% of the maximum intensity obtainable. The mask is then applied to the second set of final image data, and thus reveals only the reflections and no other features.

As an example, the reflection removal technique was carried out using a commercially available security document reader, a QS1000 available in the UK from 3M United Kingdom PLC, 3M Centre, Cain Road, Bracknell, Berkshire, RG12 8HT, UK. Minor modifications were made to the reader to split the existing array of light-emitting diodes (LEDs) into two separate half-arrays to ensure that two separate lighting sources were created. This was done by physically re-wiring the circuit board and including additional code in the software controlling the illumination to allow each half-array to be operated separately. In order to ensure that there was a one-to-one identity between corresponding pixels in any data sets obtained using either half-array, a mapping system was used to uniquely identify pixels. Each pixel was allocated a unique identifier based on its position with respect to an arbitrary x-axis corresponding to the front edge of the reader and an arbitrary-axis corresponding to a side edge of the reader, each identifier being of the format (xₙ, yₙ).

To test the reflection removal technique, the following steps were carried out, as shown in FIG. 9, a flow chart illustrating the preferred embodiment of the present invention. At step 101, a passport was opened to reveal the bio-data page, and placed face-down on the glass platen of the document reader. At step 102, the bio-data page was illuminated using the first half-array of LEDs from a first direction to capture the first raw pixel data set. At step 103, the bio-data page was illuminated from a second direction, different to the first, using the second half-array of LEDs to capture the second raw pixel data set. At step 104, the first and second sets of raw pixel data were calibrated using a set of image calibration pixel data to create a first set of image pixel data and a second set of pixel image data respectively. The set of calibration data was obtained initially when the document reader was set up to illuminate from two different directions by imaging a sheet of white 80 gsm paper. At step 105, a first set of final image data was calculated by comparing the first and second sets of image pixel data and for pixels representing the same point on the object, selecting the pixel with the lowest pixel intensity; and including said pixel in the first set of final image data. This was done by using the following loop:

For (xₙ, yₙ)
If LeftPixel < RightPixel

OutputPixel = LeftPixel

Else

OutputPixel = RightPixel

Endif

Repeat for all x (x₁-xₙ) and y, (y₁-yₙ) to create the first set of final image data comprising the OutputPixels for each (x, y). Once the first set of final image data was obtained, it was necessary to perform a gamma correction exercise to ensure that any effects of the response of the image capture device within the reader were minimised. To do this, before initial use, the image capture device was calibrated using a set of color reference targets available from X-Rite, 4300 44th St. SE, Grand Rapids MI 49512, USA. The color reference targets comprise a set of greyscale targets with known RGB values, which in conjunction with image calibration software allow a matrix of γ values to be calculated at certain points in the response of the image capture device. This matrix of γ values was then applied to the first set of final image data to correct for any inherent response behaviour in the image capture device.

As described above, a second set of image data was also created, using the loop:

For (xₙ, yₙ)
If LeftPixel > RightPixel

OutputPixel = LeftPixel

Else

OutputPixel = RightPixel

Endif

Repeat for all x (x₁-xₙ) and y, (y₁-yₙ) to create the second set of final image data comprising the OutputPixels for each (x, y). This was then used with a thresholding process (where the threshold chosen was approximately 10% of the maximum value of pixel intensity obtainable: where the maximum intensity is 255 a suitable threshold is 30) to create a mask. Consequently, images created from the darkest only pixels, where reflections were attenuated, removed or separated, and images created from the brightest only pixels with the mask applied to show specular reflections were created. In a further step, an image showing a blue reflective covert security feature was obtained by selecting pixels with a high blue response to determine the single color reflection. Finally, in order to examine the effects of ambient lighting, a set of ambient pixel data was created by removing the lid of the document reader and scanning the bio-data page, and the intensity of the pixels in each first and second sets of image pixel data was compensated for ambient light using the set of ambient pixel data obtained.

Although the technique was carried out using a passport bio-data page, it is also possible to image any other page of a passport, an identification card or a driver's license, as examples of identity documents. Other security documents, such as fiduciary documents (for example, credit or bank cards) may also be imaged using this technique. In the above example, the processing to create the various sets of data is carried out within the FPGA (field-programmable gate array) of the document reader. However, this is merely a matter of preference, and the processing could alternatively be carried out in an ASIC (application-specific integrated circuit) if desired.

In the above embodiments, images are captured from different positions, such as from different angles. This is dictated by the physical construction of a passport reader, which has a dedicated footprint limited in size due to the constraints of the areas in which such readers are often situated. A typical full page passport reader has an approximate base size of 160 mm×200 mm and a height of 160 mm. The lighting sources are typically placed adjacent a side wall, approximately 50 to 70 mm away from the wall resulting in a typical angle of illumination in the range of 10° to 60° and typically around 40° to 50° (where the angle is measured at the surface of the security document being illuminated). This is relatively wide angle illumination compared with other image capture devices, such as cameras. Consequently the first and second positions from which the security document is illuminated and the images captured from are determined by the first and second illumination angle created by the position of the first and second lighting sources. However, it is possible to create illumination and/or image capture from different relative positions without using two separate lighting sources. For example, a single image capture device can be replaced with two or more image capture devices, in conjunction with a single lighting source. Alternatively, further optical paths can be created from either a single or multiple light sources using lenses, mirrors or prisms, with each optical path yielding a relative position from which the security document may be illuminated or an image captured. Creating different relative positions from which to illuminate the security document or from which to capture images of the security document may also be achieved by moving the security document and/or the image capture device relative to each other. This could be using a motor or vibrating either the security document (for example, by moving the glass platen) or the image capture device at a fixed frequency. Creating multiple relative positions from which either the security document can be illuminated or from which images can be captured is particularly useful for identifying holographic features. Further options could also include the use of plenoptic light field cameras or the use of microlens arrays to create multiple images that appear to be imaged from multiple angles. To enhance the image quality further, it may also be desirable to use Laplacian or Gaussian smoothing functions to reduce noise or smooth the background calibration data sets.

In the embodiments described above, the approach of the present invention is applied to a security document reader to address issues involving reflections in security documents. However, the techniques may be used with other image capture devices (including, but not limited to, cameras—whether digital, video or otherwise—CMOS and CCD devices, mobile phones and other hand held devices, optical scanners, including flat bed scanners and other equipment that is capable of capturing an image) in which reflections arising from optical or physical defects or inconsistencies in the object being imaged occur. In the embodiments described above, the security document may be replaced by an object, for example a different type of document (in the case of a scanner), or a person or landscape scene (in the case of a camera). This may or may not be in contact with the image capture device, and the angle of illumination may be relatively narrow compared with the example of a passport reader above. However, illumination of the object or capture of an image of the object from at least two positions enables the darkest only pixel technique to be applied to remove reflections in images of the object. The code loops described above also apply equally well to other object types and image capture devices, since images of an object from different positions will always yield at least one image in which a reflection is present at a certain point and at least a second image where a reflection is absent at the same point, hence there will always be one bright and one dark corresponding pixel.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. An image enhancement method for an image capture device, the method comprising:
illuminating an object placed on, in or adjacent to the image capture device and capturing an image of the object from a first position to obtain a first set of raw pixel data;
illuminating the object placed on, in or adjacent to the image capture device and capturing an image of the object from a second position, to obtain a second set of raw pixel data, wherein each pixel in the second set of raw pixel data corresponds to a pixel in the first set of raw pixel data representing a point on the object;
calibrating each of the first and second sets of raw pixel data using a set of image calibration pixel data to create a first set of image pixel data and a second set of pixel image data; and
calculating a first set of final image data by: comparing the first and second sets of image pixel data; for pixels representing the same point on the object, selecting the pixel with the lowest pixel intensity; and including said pixel in the first set of final image data.

2. The image enhancement method of claim 1, wherein the calibrating step comprises using a first set of image calibration pixel data to create a first set of image pixel data and using a second set of image calibration pixel data to create a second set of pixel image data respectively, wherein each pixel in the second set of image calibration pixel data corresponds to a pixel in the first set of image calibration pixel data, and each pixel in the first and second sets of image calibration pixel data corresponds to a pixel in each of the first and second sets of raw pixel data respectively.

3. The image enhancement method of claim 1, wherein the security document is illuminated with visible light, infra-red light or ultraviolet light.

4. The image enhancement method of claim 1, wherein when the security document is illuminated with visible light, the security document is illuminated with white light.

5. The image enhancement method of claim 4, wherein the pixel intensity includes balanced red-green-blue components.

6. The image enhancement method of claim 4, wherein the pixel intensity includes un-balanced red-green-blue components.

7. The image enhancement method of claim 4, wherein the pixel intensity includes a maximum red, green or blue component.

8. The image enhancement method of claim 1, further comprising the steps of:
for each pixel in the first and second sets of raw pixel data, measuring the intensity of single color reflections, and
for pixels representing the same point on the security document, selecting the pixel with the brightest single color intensity; and including said pixel in a second set of final image data.

9. The image enhancement method of claim 1, further comprising:
adjusting the first and second sets of image pixel data with a gamma correction.

10. The image enhancement method of claim 1, wherein the image enhancement comprises the attenuation, separation, or removal of reflections.

11. The image enhancement method of claim 1, wherein the image enhancement comprises the attenuation, separation, or removal of specular reflections.

12. The image enhancement method of claim 1, further comprising:
for each of the first and second sets of raw pixel data, compensating the intensity values of each pixel for ambient light.

13. The image enhancement method of claim 12, further comprising:
creating a set of ambient pixel data by imaging the object under no illumination other than ambient light; and
subtracting the set of ambient pixel data from each of the first and second sets of raw pixel data.

14. The image enhancement method of claim 1, further comprising the steps of:
creating a second set of final image data by comparing the first and second sets of image pixel data, and thereafter for pixels representing the same point on the object, selecting the pixel with the highest pixel intensity; and
including said pixel in a second set of final image data.

15. The image enhancement method of claim 14, further comprising:
creating a mask based on the second set of final data by applying a threshold to the second set of final image data, and
applying the mask to the second set of final image data.

16. The image enhancement method of claim 1, wherein the image capture device is a security document reader and the object is a security document.

17. The image enhancement method of claim 16, wherein the security document is an identity document or a fiduciary document.

18. The image enhancement method of claim 16, wherein the security document is a passport, an identification card, or a driver's license.

19. The image enhancement method of claim 1, wherein the first position is different from the second position.

20. The image enhancement method of claim 19, wherein the first position is at a first angle relative to the object, and wherein the second position is at a second angle relative to the object.
